(19) United States
(12) Patent Application Publication
(10) Pub. No.: US 2024/0131861 A1
(43) Pub. Date: Apr. 25, 2024

(54) SPOKE-STAR UNIT MADE OF A FIBRE-REINFORCED PLASTIC

(71) Applicant: Evolime GmbH, Freinsheim (DE)

(72) Inventor: Marcel BUECKER, Kaiserslautern (DE)

(73) Assignee: Evolime GmbH, Freinsheim (DE)

(21) Appl. No.: 18/277,508

(22) PCT Filed: Feb. 21, 2022
(86) PCT No.: PCT/DE2022/100134

§ 371 Date: Aug. 15, 2023

(30) Foreign Application Priority Data
Feb. 26, 2021 (DE) 10 2021 104 740.4

(51) Int. Cl. B60B 1/04

(52) U.S. Cl. CPC B60B 1/043; B60B 1/048; B60B 2360/341

(57) ABSTRACT

A spoke star is made of a fiber-reinforced plastic and formed as a star-shaped closed ring, the spoke star having spokes between a hub-side inner circumference of the spoke star and a rim-side outer circumference of the spoke star, a single fiber bundle running repeatedly in the spoke star between the inner circumference and the outer circumference along spokes of the spoke star. The spokes may be formed as double spokes, the spokes having a loop at the rim-side outer circumference of the spoke star. The loops allow for a better load transfer to the spoke star.

The present invention relates to a spoke star made of a fiber-reinforced plastic and formed as a star-shaped closed ring, the spoke star having spokes between a hub-side inner circumference of the spoke star and a rim-side outer circumference of the spoke star, a single fiber bundle running repeatedly in the spoke star between the inner circumference and the outer circumference along spokes of the spoke star.

A spoke star is an at least approximately star-shaped structure, the rays of which are formed by spokes. A spoke star comprises at least two spokes.

Spoked wheels made of fiber composite material are known.

Vehicle wheel rims made of fiber composite material that mimic cast rims are known in the prior art. They are given their shape using fiber mats, which are placed onto a molding template. The saturated fiber mats are cured in order to produce the spoked wheel.

The disadvantage of this prior art is that preformed mold elements are needed in order to give the rim its shape. Such molds are relatively complicated to produce and are correspondingly expensive. Furthermore, they only allow for the production of a particular type of spoked wheel in a particular size. In addition, the fiber utilization in the known solutions is not ideal.

DE 10 2018 113 797 A1 describes a method for producing a spoke star comprising one or more continuous fiber bundles by way of a manufacturing device. The manufacturing device has a plurality of deflection devices on the rim side and a plurality of deflection devices on the hub side. To form the rim star, a continuous fiber bundle is wound around at least some of the rim-side deflection devices as a fiber coil and some of the hub-side deflection devices are shifted in the direction of the interior of the arrangement.

DE 94 16 688 U1 describes hubs for fastening nipples in wheels having spokes mounted in reverse. The heads of straight spokes are fastened in the rim and the spokes are tightened using nipples located in the hub or another device located on the hub. The rim end of a spoke made of fiber composite materials can be mounted in a slot running parallel to the wheel plane, and the rim end can form a closed eye or an eye that is open to the wheel axle. This eye contains a retaining pin which prevents the spoke from being pulled out due to the tractive force.

DE 10 2007 026 782 A1 concerns a rim made of fiber composite material. The spoke end or the individual ends of the spoke can be guided in a loop around a structural element of the rim, which can be a roving portion, a stitching that engages in the loop or/and an already pre-consolidated structural element.

DE 10 2008 007 722 A1 describes a wheel spoke having a traction spoke. The spokes are made of a composite material and include a tapered traction body, the body having an intermediate portion and two ends. The body is extended beyond each end by a fastening segment, the body and the fastening segments being connected by a transition region. The spoke has at least one portion with a reinforced cross-section on the surface relative to the cross-section of the intermediate portion, the portion with the reinforced cross-section at least covering the transition region between the traction body and the fitted fastening segment. The fastening element can be sandwiched between two layers of the rim and hence fitted against the inner wall of the rim.

DE 10 2008 046 255 B3 describes a spoke made of carbon fibers for a bicycle wheel, having an eye formed on at least one end, the eye being divided by carbon fibers into two mutually separated opening regions. A core made out of material that is substantially incompressible with respect to forces acting when the spokes are tensioned is inserted into each opening region. A further eye having just one opening region can be located at the other end of the spoke. The opening region is semi-circular on one side and tapered on the other side. A tensioning block with an engagement element engages in the eye and fixes it to the hub.

DE 10 2017 116 754 A1 describes a system wheel with spokes based on high-performance fibrous materials. Here, the spoke can be tensioned with at least one tensioning element, and the cross-section of the spoke is square when it is untensioned and substantially round when it is tensioned.

DE 10 2017 219 061 B4 relates to a wheel of a vehicle consisting of a rim for receiving a tire of the wheel and a hub with the spokes connecting the rim. The spokes consist of a spoke portion made of an injection molded thermoplastic polymer material, in which at least one spoke reinforcing element, consisting at least in part of fiber-reinforced plastic, is at least partly embedded. A loop of the reinforcing element projecting from the spoke on the rim side is guided radially outwardly around at least one portion of the rim reinforcing element.

EP 0 089 809 A1 describes a method for producing fiber-reinforced objects from fibrous material, which is bonded in a curable matrix material, by resin injection molding. The objects comprise two or more spokes, which extend from a hub portion. Each spoke is in the form of a loop. The fibrous material is arranged such that at least as many rovings of the fibrous material as there are spokes extend in continuous paths from the hub portion around each of the spokes. Each of the rovings is overlaid for at least part of its length by each of the other rovings.

DE 298 24 507 U1 relates to a composite spoke core for a wheel with spokes which are subject to tensile loading. The composite spoke core comprises a continuous winding of a plurality of turns of a fiber according to at least two parallel, straight portions, which are joined at the ends thereof by two rounded portions. The straight portions can be combined here to form a one-piece strand. The core can have at each end a fastening piece for connecting to the rim and the hub. The fastening piece consists of a bolt or a bolt portion which engages on the inside of the continuous winding of the core.

EP 1 800 897 B1 describes a wheel comprising a rim, a hub and at least one device for connecting the rim to the hub. The connecting device comprises a composite spoke and a first means for connecting the spoke to the rim or the hub, the spoke comprising an elongate body that extends along a longitudinal direction between a first end and a second end. The body and the ends contain fibers, the fibers being arranged to form a first loop at the first end. The first connecting means comprises a first insert piece arranged in the first loop and a first rod fastened to the first insert piece, the first rod being aligned in the longitudinal direction and a first screw connection part or fastening part being defined on the first rod.

US 2008/0315675 A1 concerns a wheel consisting of a rim, a hub and at least one spoke, which connects the rim to the hub. The spoke consists of a composite material, each spoke having a connecting element for releasably connecting the spoke to the hub. The connecting element is at least partly incorporated in the spoke by being molded together with the spoke. The connecting element can be a shouldered pin. The spoke can be a double spoke.

WO 1 991/013771 A2 describes a non-rigid spoke which comprises a central part extending between a first and a second end, a first fastening means fastened at a first end of the spoke and a second fastening means arranged at the other end of the spoke. One of said fastening means can include an eyehook.

WO 2010/057857 A1 concerns a wheel, in particular for bicycles or motorcycles, having a rim which in cross-section is polygonal in shape, preferably V-shaped. The rim has in the interior region thereof an arcuate insert or a guide for the resting and sliding of a complementarily shaped end of a spoke which is shaped like an open loop. The ends of the spoke can be inserted at correspondingly provided openings arranged in the rim in a region that is adjacent to the arcuate guide or the insert.

The problem addressed by the present invention is that of optimizing spoke stars made of fiber-reinforced plastic.

The problem is solved in a spoke star according to the preamble of claim 1 in that the spokes are formed as double spokes, the spokes having a loop at the rim-side outer circumference of the spoke star.

A fiber bundle is preferably a bundle of a plurality of continuous fibers, for example a roving or a plurality of rovings, which in particular have a unidirectional fiber orientation, or a strip, a towpreg, an elongate prepreg or an elongate laid or woven fabric. A continuous fiber, the German term for which translates literally as “endless fiber”, is not in fact infinitely long. In this application, a continuous fiber is defined as a fiber having the special property of being longer than a spoke. It is also possible, however, to join fibers that are shorter than a spoke to form a longer fiber bundle, which can then be used.

A spoke star can be provided, for example, as part of a spoked wheel. It can be used to connect a hub to a wheel rim. The spoke star preferably has an integer number of spokes. The spoke star preferably has rotationally symmetric portions, in particular portions that each comprise two spokes.

A double spoke is formed by two spokes running in parallel. The spokes run approximately in parallel from the hub-side inner circumference of the spoke star to the rim-side outer circumference of the spoke star. The fiber orientation is reversed through 180° by the loop on the rim-side outer circumference of the spoke star. In the two spokes of the double spoke, the fibers run substantially in parallel and in opposite directions.

The spoke star according to the invention can be produced in the wet winding process. Advantageously, the fiber type and plastic matrix can be adapted to the requirements of the spoke star. The two spokes of the double spokes can be connected by the plastic matrix during the process of producing the spoke star.

The fibers in the spokes are advantageously arranged in parallel. Through this arrangement of the fibers, optimum advantage can be taken of the stiffness and strength of the fibers. In this way, material can be saved in the production of the spoke star, and this advantageously also reduces the weight of the spoke star. Not only through the use of carbon fibers having a low specific weight but also by using materials in the most efficient way, the objectives of lightweight construction are thus met.

The spoke star is manufactured continuously as a closed ring made of fiber composite material. The spoke star preferably contains no open fiber bundles. This permits a better load transfer within the spoke star.

Advantageously, the hub-side inner circumference of the spoke star and the rim-side outer circumference of the spoke star can have loops for connecting the spoke star to the hub and to the wheel rim, respectively. These loops permit an advantageous load transfer. The loops allow the spoke star to be fastened to bolts arranged on the hub, rendering further fastening elements superfluous and resulting in a weight saving.

In the embodiment of the rim-side outer circumference of the spoke star as loops, the loops preferably have half the diameter of the double spokes. This preferably reduces the stress while maintaining the same tractive force.

The two spokes of the double spokes can preferably be joined in such a way that the double spokes have the smallest cross-section in the direction of travel. Particularly preferably, the two spokes of the double spoke are arranged in parallel and offset in the direction of travel. This arrangement of the spokes advantageously allows for an aerodynamic shape. The shape of the double spoke can advantageously be modified during the process of producing the spoke star by way of the cavity of the mold. Particularly advantageously, the double spoke can be embodied in an elliptical form in this way. This is particularly advantageous in aerodynamic terms.

The spoke arrangement within the spoke star can mimic that of conventional wheels with steel spokes. The load transfer principles known from steel spokes can be used as a basis for this spoke arrangement. Advantageously, no new calculations, simulations and experiments regarding the load transfer in the spokes are required. Reference can be made to experience with conventional rims.

Advantageously, assembly is simplified by the spoke star according to the invention. For each side of the hub flange, two identical spoke stars, turned towards each other, are inserted onto the hub. On the hub-side inner circumference of the spoke star, the spoke stars can be fixed to bolts of the hub by way of loops. An interlocking connection is preferably made here. Advantageously, the rim-side outer circumference of the spoke star with the loop located on the rim-side end of the double spokes preferably points directly towards the rim holes in the wheel rim for fastening and tensioning the spoke star on the wheel rim. Particularly advantageously, the radial and lateral runout and the centering of the spoked wheel can be adjusted by tensioning the spoke star.

The spoke star according to the invention particularly preferably enables damaged spoke stars to be replaced particularly easily and quickly. Thus, if a spoke star is damaged, only the spoke star rather than the entire spoked wheel needs to be replaced. This reduces the repair costs and allows for a resource-efficient repair.

In a preferred embodiment of the invention, at least one spoke has a fastening means on the loop thereof.

The fastening means serves to fasten the spoke star to the wheel rim. The fastening means can be inserted into the loop of the spoke star.

The fastening means can be releasably connected to the wheel rim.

It is convenient here for the fastening means to be interlockingly connectable to the loop.

Particularly preferably, an interlocking connection can be made between the spoke star and the fastening means. There is no need for the fastening means to be glued.

In an embodiment of the invention, the fastening means can be fixed to a wheel rim using a screw.

The screw allows for a particularly easy, fast and secure connection of the fastening means to the wheel rim. The spoke star can advantageously be pretensioned with the screw. The radial and lateral runout and the centering of the spoked wheel can be adjusted by tensioning the spoke star.

The screw can be embodied as a ball-head screw.

It is convenient here for the screw to align with the spoke.

To this end, the loop can be bent slightly out of the plane. Advantageously, the loop is additionally secured in the fastening means by the screw in an interlocking manner. The screw advantageously prevents the loop from “popping out” of the fastening means.

The fastening means also prevents the loop from “lifting up”. This is achieved through the lateral support of the loop outlet by the “jaws” of the fastening means.

Bending moments on the spoke star are advantageously prevented. Particularly advantageously, the load transfer between the spoke star and the wheel rim is optimized.

Lastly, in a further aspect of the invention, a spoked wheel having a hub, a wheel rim and a plurality of spokes between the hub and the wheel rim is proposed. The spoked wheel comprises a spoke star according to one of the preceding embodiments.

A spoke star can be fastened to a wheel rim and to a hub to form a spoked wheel. The spoke star can be fastened to the hub by loops of the spoke star, which are hooked into bolts on the hub. The spoke star can be fastened to the wheel rim by way of the fastening means according to the invention.

The figures show exemplary embodiments of the invention.

In the drawing:

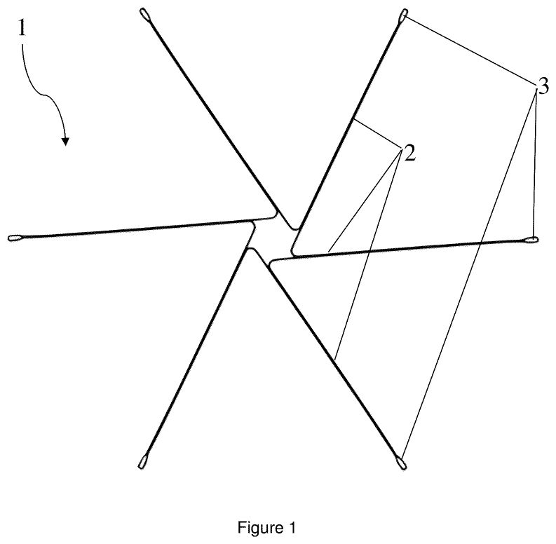

FIG. 1 shows a side view of an individual spoke star according to the invention,

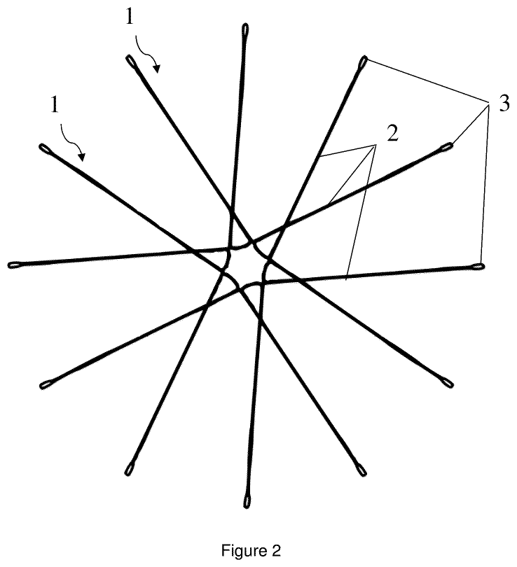

FIG. 2 shows a side view of an arrangement of two spoke stars according to the invention from FIG. 1,

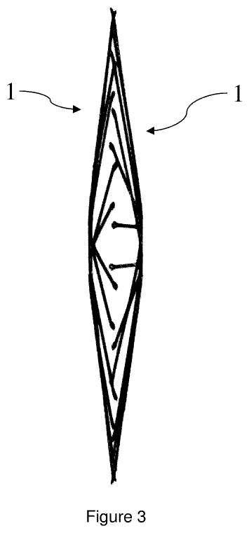

FIG. 3 shows a top view of a pair of the arrangement from FIG. 2,

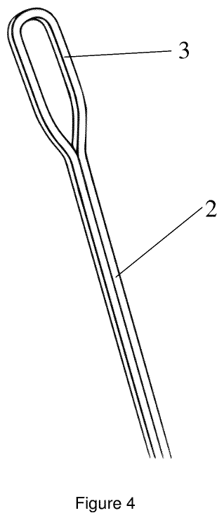

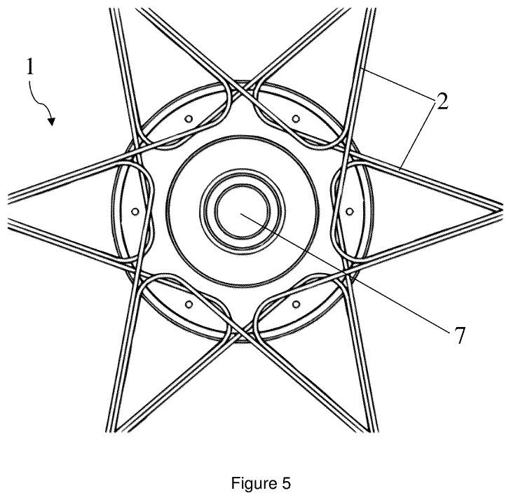

FIG. 4 shows a side view of the rim-side outer circumference of the spoke star according to the invention,

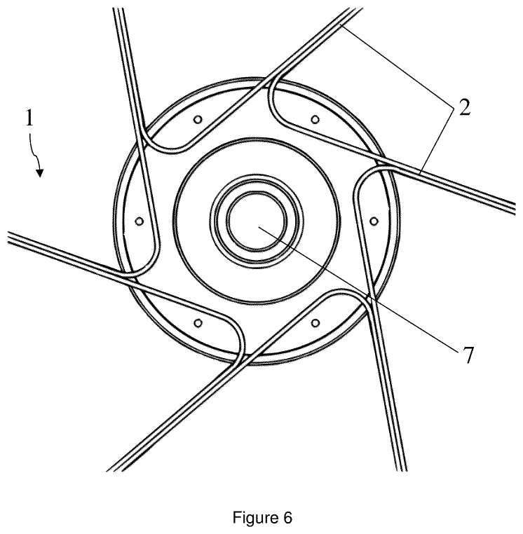

FIG. 5 shows a side view of the hub-side inner circumference of the arrangement from FIG. 2 with a hub,

FIG. 6 shows a side view of the hub-side inner circumference of the spoke star from FIG. 1 with a hub,

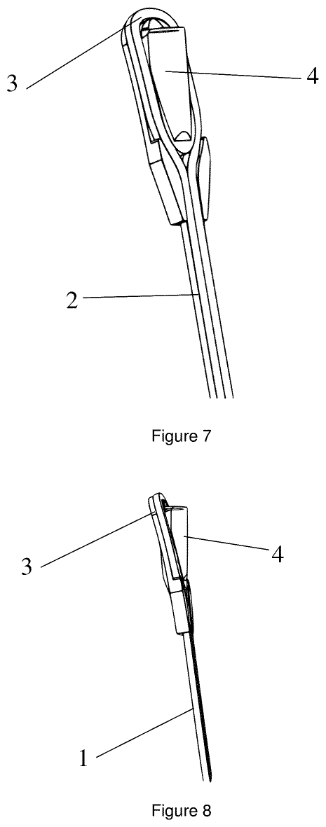

FIG. 7 shows a perspective view of the rim-side outer circumference of the spoke star according to the invention with fastening means,

FIG. 8 shows a side view of the rim-side outer circumference of the spoke star with fastening means from FIG. 7,

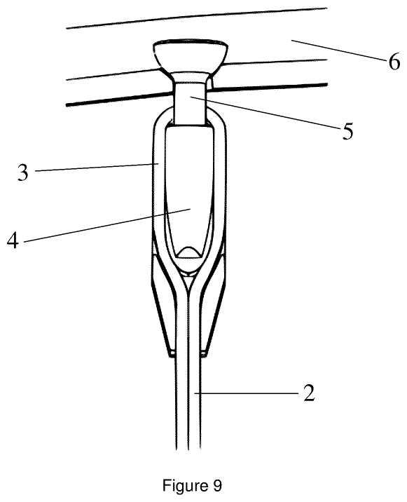

FIG. 9 shows a side view of the rim-side outer circumference of the spoke star with fastening means from FIG. 7, mounted on a wheel rim,

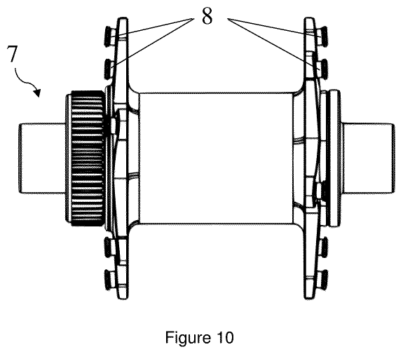

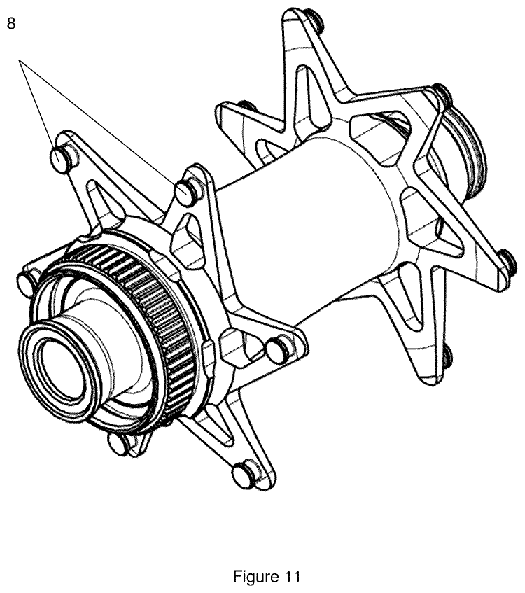

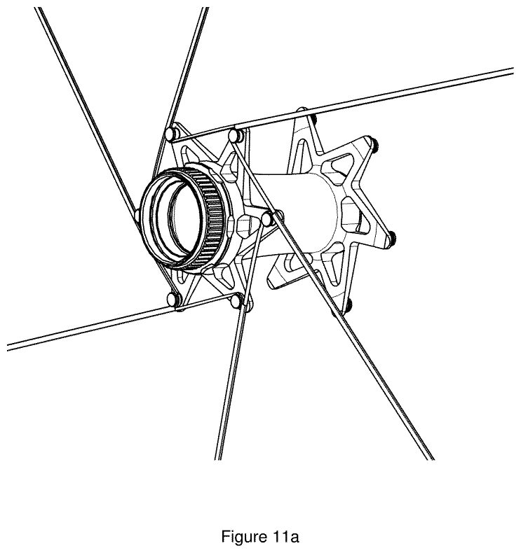

FIG. 10 shows a side view of a hub according to the invention,

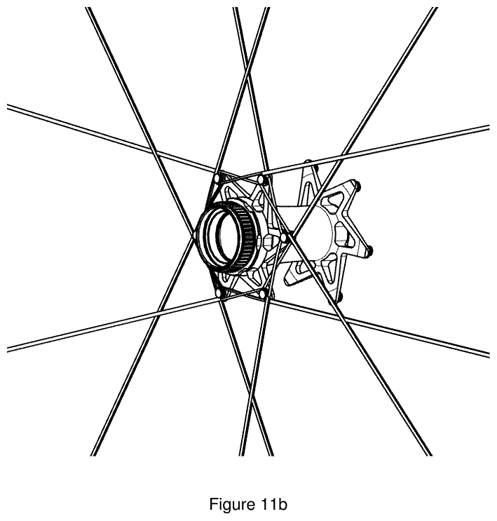

FIGS. 11, 11a and 11b show perspective views of a hub according to the invention before securing the spoke star, with a first mounted spoke star and with a second mounted spoke star.

FIGS. 1 to 3 show schematic views of an embodiment of the spoke star 1 according to the invention. FIG. 1 shows an individual spoke star 1. FIG. 2 shows an arrangement of two spoke stars 1 from FIG. 1. The spoke stars 1 are turned through 180° C. relative to one another. The arrangement can form one side of a spoked wheel. FIG. 3 shows two arrangements from FIG. 2. The two arrangements are turned slightly relative to one another and form the two sides of the spokes of a spoked wheel.

The spoke star 1 consists of a fiber-reinforced plastic material. The spoke star 1 has spokes 2 between a hub-side inner circumference of the spoke star and a rim-side outer circumference of the spoke star. In the spoke star 1, a single fiber bundle runs repeatedly between the inner circumference and the outer circumference along spokes 2 of the spoke star. The spokes 2 are formed as double spokes. A double spoke is formed by two spokes 2 running in parallel. The spokes 2 run approximately in parallel from the hub-side inner circumference of the spoke star to the rim-side outer circumference of the spoke star. The spokes 2 have a loop 3 on the rim-side outer circumference of the spoke star. The fiber orientation is reversed through 180° by the loop 3 on the rim-side outer circumference of the spoke star. In the two spokes 2 of the double spoke, the fibers run substantially in parallel and in opposite directions. On the hub-side inner circumference of the spoke star, loops are provided for the interlocking connection of the spoke star to a hub 7.

FIG. 4 shows a detailed view of the rim-side outer circumference of a spoke star 1 according to the invention. The double spokes 2 have a loop 3 on the rim-side outer circumference of the spoke star. The fiber orientation is reversed through 180° by the loop 3 on the rim-side outer circumference of the spoke star. In the two spokes 2 of the double spoke, the fibers run substantially in parallel and in opposite directions. By reason of the embodiment of the rim-side outer circumference of the spoke star as loops, the loops 3 have half the diameter of the double spokes 2.

FIG. 5 shows a detailed view of the hub-side inner circumference of the arrangement from FIG. 2. The spoke star can be interlockingly connected to a hub 7 by way of the loops on the hub-side inner circumference of the spoke star.

FIG. 6 shows a detailed view of the hub-side inner circumference of the individual spoke star 1 from FIG. 1. The spoke star can be interlockingly connected to a hub 7 by way of the loops on the hub-side inner circumference of the spoke star.

FIGS. 7 and 8 show a schematic representation of a spoke star 1 according to the invention with fastening means 4. The fastening means 4 is inserted into the loop 3 located on the rim-side outer circumference of the spoke star. The fastening means 4 is interlockingly connected to the spoke star 1 in this way. The fastening means 4 can be connected to a wheel rim 6 using a screw 5. As can be seen in FIG. 8, the loop 3 is slightly bent out of the plane. In this way, in the assembled state of the spoke star 1, the loop 3 can additionally be secured in the fastening means 4 in an interlocking manner by a screw 5. The screw 5 advantageously prevents the loop 3 from “popping out” of the fastening means 4.

FIG. 9 shows a representation of the spoke star 1 with fastening means 4 from FIGS. 7 and 8 mounted on a wheel rim 6. The fastening means 4 is fastened to the wheel rim 6 with a screw 5. By forming an interlocking connection, the screw 5 additionally prevents the loop 3 from popping out of the fastening means 4. The screw 5 aligns with the double spoke 2.

FIGS. 10 and 11 schematically illustrate an embodiment of a hub 7 of a spoked wheel with a spoke star 1 according to the invention. The hub 7 has bolts 8 for interlockingly connecting the spoke star 1 to the hub 7, in which the loops 3 of the spoke star 1 engage.

In the assembled state, the bolts 8 engage in loops on the hub-side inner circumference of the spoke star 1. FIGS. 11a and 11b show how, firstly, a first spoke star 1 is fastened on the hub-side inner circumference of the spoke star 1 by engagement of the bolts 8 in loops 3, followed by—offset by 180°—a second spoke star 2.

1. A spoke star (1) made of a fiber-reinforced plastic and formed as a star-shaped closed ring, wherein the spoke star (1) comprises at least two spokes (2) between a hub-side inner circumference of the spoke star and a rim-side outer circumference of the spoke star, wherein a single fiber bundle runs repeatedly in the spoke star between the inner circumference and the outer circumference along spokes (2) of the spoke star, wherein the spokes (2) are formed as double spokes, wherein the two spokes (2) of the double spokes are connected by a plastic matrix and the spoke arrangement within the spoke star (1) mimic that of conventional wheels with steel spokes, wherein the spokes (2) on the rim-side outer circumference of the spoke star have a loop (3) and the spokes (2) on the hub-side inner circumference of the spoke star have a loop.

2. The spoke star (1) according to claim 1, wherein at least one spoke (2) comprises a fastening means (4) on the loop (3) thereof.

3. The spoke star (1) according to claim 2, wherein the fastening means (4) is interlockingly connectable to the loop (3).

4. The spoke star (1) according to claim 2, wherein the fastening means (4) is fixable to a wheel rim (6) by way of a screw (5).

5. The spoke star (1) according to claim 4, wherein the screw (5) aligns with the spoke (2).

6. A spoked wheel having a hub (7), a wheel rim (6) and a plurality of spokes (2) between the hub (7) and the wheel rim (6), wherein the spoked wheel comprises at least one spoke star (1) according to claim 1.
